(19) United States
(12) Patent Application Publication
(10) Pub. No.: US 2012/0062532 A1
(43) Pub. Date: Mar. 15, 2012

(54) ELECTRO-OPTICAL DEVICE AND ELECTRONIC APPARATUS

(75) Inventor: Kenya Watanabe, Suwa-shi (JP)

(73) Assignee: SEIKO EPSON CORPORATION, Tokyo (JP)

(21) Appl. No.: 13/320,041

(22) PCT Filed: Mar. 11, 2010
(86) PCT No.: PCT/JP2010/001751

§ 371 Date: Nov. 11, 2011

(30) Foreign Application Priority Data
May 13, 2009 (JP) 2009-116713

(51) Int. Cl. G09G 5/00

(52) U.S. Cl. 345/204

(57) ABSTRACT

The electro-optical device includes a first electrode for inverting a polarity, a second electrode opposite to the first electrode, and liquid crystals interposed between these electrodes. Before a polarity inversion timing, the scanning line driver circuit simultaneously selects two or more scanning lines of the plural scanning lines, and the data line driver circuit outputs an offset potential with the polarity opposite to that of the potential of the first electrode thereafter, to a data line. On the other hand, after the polarity inversion timing, the scanning line driver circuit individually selects each of the plural scanning lines, and the data line driver circuit outputs the data potential corresponding to the potential polarity of the first electrode thereafter, to the data line.

### TECHNICAL FIELD

The present invention relates to an electro-optical device which includes an electro-optical material such as liquid crystals, and an electronic apparatus which includes the electro-optical device.

### BACKGROUND ART

As an electro-optical material which varies in its optical characteristics according to electric energy, liquid crystals are known. Liquid crystals vary in their transmittance according to an applied voltage. The variation in the transmittance can be obtained by making the orientation state of the liquid crystal molecules vary according to the applied voltage. In addition, the liquid crystals have a characteristic in which when a direct current voltage is applied for a long time, it is difficult to return the orientation state back to its original state. For this reason, in a liquid crystal display device which is manufactured by applying the liquid crystals to a display device, an alternating current driving that inverts the polarity of the voltage applied to the liquid crystal element (that is, an electro-optical element) has been employed.

The liquid crystal display device includes a plurality of scanning lines, a plurality of data lines, and a plurality of pixels which is provided corresponding to the intersections of the scanning lines and the data lines. Each of the plurality of the pixels has a pixel electrode, a counter electrode, and a liquid crystal element which includes the liquid crystals interposed between these electrodes.

As a scheme that inverts a voltage applied to the liquid crystal element, a scheme is known that fixes a potential of the counter electrode (hereinafter, referred to as a counter electrode potential) and inverts the polarity of the data potential supplied via the data line centering around the counter electrode potential. In addition, Patent Literature 1 discloses a scheme in which the polarity of the counter electrode potential is inverted on the basis of the amplitude of the data potential, and also the polarity of the data potential is inverted.

### Citation List

### Patent Literature

[PTL 1] JP-A-2005-241741

### SUMMARY OF INVENTION

### Technical Problem

However, the scheme of inverting the polarity of the counter electrode potential as described above has the following problems. In other words, in addition to the pixel electrode, the counter electrode and the liquid crystal element, the pixel may include a switching transistor which serves to determine whether or not the data potential is written to the liquid crystal element, or may include a retentive capacitance which maintains the data potential for improving the application of the data potential to the liquid crystal element. In such a case, when the polarity of the counter electrode potential is inverted as described above, the coupling action of the retentive capacitance or the liquid crystal element works, so that there is concern that the potential in the pixel (for example, the potential of the pixel electrode and the like) may vary.

In addition, in order to operate the liquid crystal display device without any problem even when an extra potential variation as described above occurs, it is necessary to improve the breakdown voltage performance of the switching transistor. Therefore, a useless reaction of the switching transistor with respect to the extra potential variation can be avoided, or the damage can be prevented before it happens.

However, an improvement of the breakdown voltage performance requires that the switching transistor increase in size, so that it becomes an obstacle to increasing the definition of the display image.

An advantage of some aspects of the invention provides an electro-optical device and an electronic apparatus, which are capable of solving at least a part of the above-mentioned problems.

In addition, another advantage of some aspects of the invention is that it provides an electro-optical device and an electronic apparatus which are capable of solving the problems relating to the electro-optical device and the electronic apparatus as described above.

### Solution to Problem

In accordance with an embodiment of the invention, there is provided an electro-optical device in order to solve the above-mentioned problems. The electro-optical device includes a plurality of the pixels that are arranged in correspondence with intersections between a plurality of the scanning lines and a plurality of the data lines; a polarity inversion unit that inverts a potential polarity of first electrodes at every constant period, the first electrodes constituting a part of the pixel; a scanning line driver circuit that simultaneously selects two or more scanning lines of the plurality of the scanning lines or individually each of the plurality of the scanning lines until all the plurality of the scanning lines are selected; and a data line driver circuit that outputs a data potential corresponding to a potential polarity of the first electrode to each of the plurality of the data lines. In the electro-optical device, each of the plurality of the pixels includes a second electrode that faces the first electrode, an electro-optical material that is interposed between the first and the second electrode, and a switching element that is disposed between the second electrode and the data line and comes to be in an electrically connected state by selecting one scanning line corresponding to a pixel among the plurality of the scanning lines so as to make the second electrode electrically connected with a corresponding data line. Further, before a first time point that is an inversion point at which the polarity inversion unit inverts a potential polarity of the first electrode, the scanning line driver circuit simultaneously selects two or more scanning lines of the plurality of the scanning lines, and the data line driver circuit outputs an offset potential which has a potential opposite to a potential polarity of the first electrode after the first time point to the data line. Further, after the first time point, the scanning line driver circuit individually selects each of the plurality of the scanning lines, and the data line driver circuit outputs the data potential corresponding to a potential polarity of the first electrode after the first time point to the data line.

According to the invention, first, while the potential polarity of the first electrode is inverted, the data potential corresponding to the polarity is supplied to the second electrode. Therefore, application of one direction of voltage to the liquid crystal, which is an example of the electro-optical material, is avoided, so that the speed of degradation can be prevented. Further, the “polarity” described in the specification is based on an assumption in which there are a potential greater than the center potential and a potential less than the center potential on the basis of a predetermined constant center potential. In this case, each of these two kinds of potentials means the “polarity” (or, a positive polarity and a negative polarity on the basis of the center potential), and an “inversion” of the polarity means switching from the former to the latter, or from the latter to the former.

Particularly, in the invention, on the assumption that such a polarity inversion driving is performed, a characteristic writing operation is performed before and after the first time point which is a polarity inversion time point. In particular, before the first time point, the offset potential is written to the second electrode or the pixel. Therefore, in the invention, even when the second electrode potential varies for some reason (for example, the coupling action as described above) according to the polarity inversion of the first electrode potential. The amplitude corresponding to the potential variation can be absorbed into the offset potential by making the offset potential serve as a kind of buffer. Therefore, in the invention, it is not necessary to increase the size of “a switching element” as the component, and the full effect can be obtained if a component for a low voltage is prepared. Further, for the same reason, according to the invention, the pixels can be arranged with high density.

In addition, according to the invention, the writing operation of the offset potential producing such effects is performed prior to the writing operation of the data potential which is performed after the first time point. In the former writing operation, two or more scanning lines are selected simultaneously, and in the latter writing operation an individual selection is performed.

As described above, in consideration of the reality that the image display is actually difficult to perform between both the writing operations described above, the earlier writing operation of the offset potential contributes to the reduction of the image non-display period in this sense, and in other words it contributes the extension of the image display period. As a result, according to the invention, the maintenance and the improvement of the display characteristics such as displaying a brighter image can be realized.

The electro-optical device according to the embodiment of the invention may be configured such that a potential of the first electrode includes two types of values, V1 and V2, and the offset potential becomes V2 when a potential of the first electrode is V1, and becomes V1 when the potential of the first electrode is V2.

According to the embodiment, since the offset potential is defined to have the value exactly opposite to the value of the first electrode potential, the above-mentioned operational advantage relating to the offset potential can be obtained to the fullest.

Further, contrary to the definition of the embodiment, it is not required that the offset potential has exactly the same value as the first electrode potential (excluding the difference of the polarity). For example, as in the embodiment, the case where the polarity of the first electrode is inverted just like V1->V2->V1-> . . . , and also the case where the polarity of the offset potential is inverted just like V3->V4->V3-> . . . (In this regard, if V1 is less than V2 (V1<V2), V1<V3, V4<V2, and V3<V4) are included within the general scope of the invention.

In addition, the electro-optical device according to the embodiment of the invention may be configured such that the scanning line driver circuit selects a first, a second, . . . , and an n-th scanning lines which are of the plurality of scanning lines, from the first to the n-th or from the n-th to the first.

According to the embodiment, it may invert the selection direction of the plurality of the scanning lines or may not change the previous selection direction. Therefore, by appropriately determining the selection direction of the plurality of the scanning lines, for example, an imbalance in displaying due to a constant length of the scanning lines or the data lines, or an imbalance in displaying based on difference characteristics of the pixels or the switching elements which are the components thereof can be removed.

In the embodiment, at every first time point, the scanning line driver circuit may be configured to invert the selection direction when two or more scanning lines of the plurality of scanning lines are simultaneously selected before the first time point, with respect to the selection direction immediately before the first time point, and to invert the selection direction when the plurality of the scanning lines are individually selected after the first time point, with respect to the selection direction immediately before the first time point.

According to the embodiment, the selection direction of the scanning lines relating to the offset potential writing operation is inverted at every first time point, and the selection direction of the scanning lines relating to the data potential writing operation also is inverted at every first time point. Therefore, if the selection direction of the scanning lines is inverted by being triggered at the advent of the first time point, a bias in the image display period can be removed with respect to all of the scanning lines.

Further, a specific example according to the embodiment will be described in the following embodiment with reference to FIGS. 10 and 11.

In the embodiment, at the specific first time point, the selection direction when the plurality of the scanning lines are individually selected after the first time point may be configured to be inverted with respect to the selection direction when two or more scanning lines of the plurality of the scanning lines are simultaneously selected before the first time point.

According to the embodiment, in addition to the inversion of the selection direction of the scanning lines between the first time points which are adjacent as described above, the selection direction of the scanning lines relating to the writing operations of the offset potential and the data potential in which the first time point is interposed is also inverted.

According to such an embodiment, when the offset potential writing operation before the specific first time point is completed at the n-th scanning line, the data potential writing operation immediately starts from the n-th scanning line. Therefore, further reductions of the image non-display period described above, or further extensions of the image display period can be achieved.

Further, a specific example according to the embodiment will be described in the following embodiment with reference to FIG. 10.

Alternatively, in the embodiment in which the selection direction of the scanning line is inverted by being triggered at the advent of the first time point, at the specific first time point, the selection direction when the plurality of the scanning lines are individually selected after the first time point may be configured to be the same as the selection direction when two or more scanning lines of the plurality of the scanning lines are simultaneously selected before the first time point.

According to the embodiment, the selection direction of the scanning lines between the above-mentioned adjacent first time points is inverted, but the selection direction of the scanning lines relating to the writing operations of the offset potential and the data potential in which the specific first time point is interposed is not inverted.

According to such an embodiment, when the offset potential writing operation before the specific first time point is completed at the n-th scanning line, the subsequent data potential writing operation starts from the first scanning line. As described above, after the writing operation relating to the n-th scanning line is completed, the writing operation is not performed on the same scanning line immediately. Therefore, while the concern about the influence of the former writing operation on the latter writing operation can be avoided, these overall writing operations can be performed more accurately.

Further, a specific example according to the embodiment will be described in the following embodiment with reference to FIG. 11.

Further, in the embodiment in which the selection direction of the scanning line can be inverted, when one scanning line of the plurality of the scanning lines is selected at a second time point at which the plurality of the scanning lines are individually selected after the first time point and at a third time point at which two or more scanning lines of the plurality of the scanning lines are simultaneously selected before a new first time point after the first time point, and when another scanning line of the plurality of the scanning lines is selected at a fourth time point corresponding to the second time point and at a fifth time point corresponding to the third time point, the total sum of a predetermined period from the second time point to the third time point when the first time point is repeated may be configured to be the same as the total sum of a predetermined period from the fourth time point to the fifth time point when the first time point is repeated.

According to the embodiment, the length between the image display period for the pixel corresponding to one scanning line and the image display period for the pixel corresponding to the other one scanning line is balanced by being equalized during the predetermined period. As described above, according to the embodiment, there is no bias in the image brightness depending on positions of the pixels, and the image display can be realized with high quality.

In the embodiment, the predetermined period may be configured to be the same as a period during which the constant period is repeated an even number of times.

According to the embodiment, for example, when the polarity inversion of the first electrode is performed three times (that is, when the first time point is repeated three times), the length of the image display period becomes balanced for the two constant periods as described above. It can be said that when the constant period is repeated an odd number of times, the invention does not exclude an aspect for balancing the length, but comparing with this the embodiment can realize the balancing more easily.

In addition, the electronic apparatus according to an embodiment of the invention includes various kinds of the electro-optical devices described above in order to solve the above-mentioned problems.

The electronic apparatus according to the invention includes various kinds of the electro-optical devices as described above, so that above-mentioned various kinds of operational advantages are provided and the image display can be implemented with high quality.

### BRIEF DESCRIPTION OF DRAWINGS

FIG. 1 shows a block diagram illustrating the entire configuration of an electro-optical device according to the first embodiment of the invention.

FIG. 2 shows a circuit diagram specifically illustrating a pixel which is included in the electro-optical device of FIG. 1.

FIG. 3 shows a timing chart illustrating the operation of the electro-optical device of FIG. 1.

FIG. 4 shows an explanatory diagram illustrating the case where the transfer direction, the selection order of the scanning lines of FIG. 3, is inverted in the vertical direction.

FIG. 5 shows an explanatory diagram illustrating the case where a plurality of scanning lines is simultaneously selected with respect to the selection order of the scanning lines of FIG. 3.

FIG. 6 shows an explanatory diagram illustrating an offset potential writing operation, in conjunction with a common potential inverting operation, which is a feature of the operation of the electro-optical device according to the first embodiment.

FIG. 7 shows an explanatory diagram illustrating the relationship between an average selection rate of all the scanning lines relating to the offset potential writing operation which is the feature of the electro-optical device and an average selection rate of all of the scanning lines relating to the data potential writing operation, according to the first embodiment.

FIG. 8 shows a diagram illustrating a comparative example of FIG. 6.

FIG. 9 shows a diagram illustrating a comparative example of FIG. 7.

FIG. 10 shows an explanatory diagram showing the same effect as that of FIG. 7, and illustrating the feature of the scanning line transfer direction in the offset potential writing operation and the data potential writing operation, according to a second embodiment of the invention.

FIG. 11 shows an explanatory diagram showing the same effect as that of FIGS. 7 and 10, and illustrating the feature of the scanning line transfer direction in the offset potential writing operation and the data potential writing operation, according to a third embodiment of the invention.

FIG. 12 shows an explanatory diagram showing the same effect as that of FIGS. 7 and 10, and illustrating a modified example (the combination of FIGS. 10 and 11) according to the embodiments of the invention.

FIG. 13 shows a perspective diagram illustrating the electronic apparatus to which the electro-optical device according to the invention is applied.

FIG. 14 shows a perspective diagram illustrating another electronic apparatus to which the electro-optical device according to the invention is applied.

FIG. 15 shows a perspective diagram illustrating still another electronic apparatus to which the electro-optical device according to the invention is applied.

### DESCRIPTION OF EMBODIMENTS

### First Embodiment

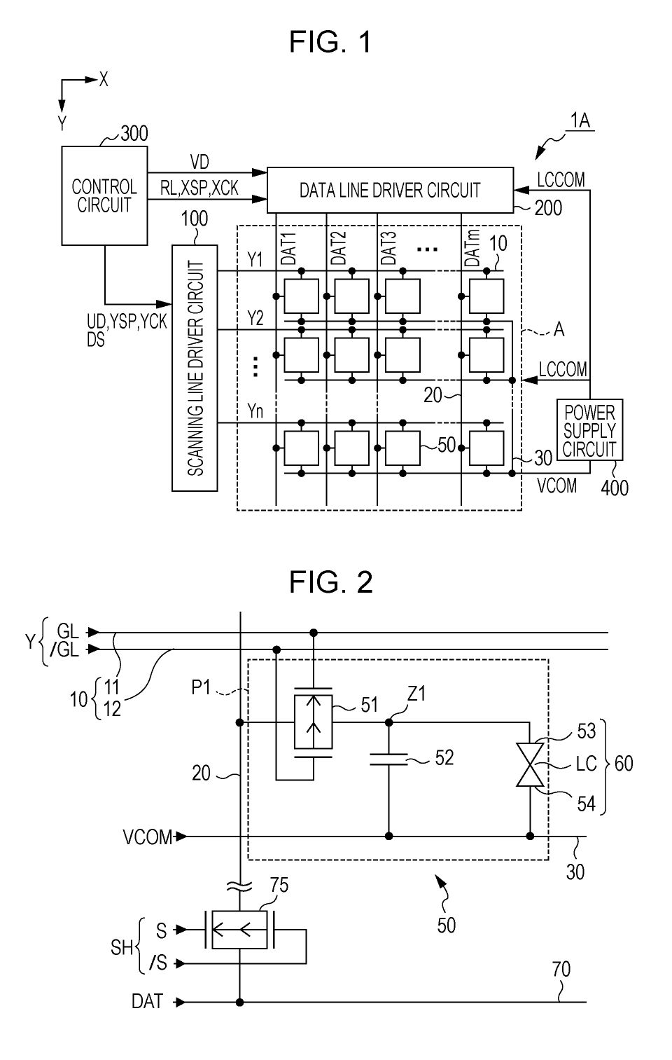

In the following, the first embodiment according to the invention will be described with reference to FIGS. 1 and 2. Further, in the drawings to be described below including FIGS. 1 and 2 described herein, the dimensions of the respective sections may be different suitably in ratio from the actual ones.

An electro-optical device according to the embodiment of the invention uses the liquid crystals as an electro-optical material. The electro-optical device 1A includes a liquid crystal panel (which is an example of the electro-optical panel) as a main section. The liquid crystal panel is configured such that an element substrate on which Thin Film Transistors (hereinafter, referred to as “TFT”) are formed and a counter substrate are disposed to face their electrode formed surfaces to each other, and attached with a constant gap therebetween, and then the liquid crystals are interposed in the gap.

FIG. 1 is a block diagram illustrating the entire configuration of the components of the electro-optical device 1A according to the first embodiment. The electro-optical device 1A includes a scanning line driver circuit 100, a data line driver circuit 200, a control circuit 300, a power supply circuit 400, and an image display area A. Among these components, the liquid crystal panel includes at least the image display area A, and the power supply circuit 400 may be configured as an external circuit of the liquid crystal panel. The scanning line driver circuit 100, the data line driver circuit 200, and the control circuit 300 may be mounted on the liquid crystal panel, or may be configured as external circuits. In this example, the image display area A, the scanning line driver circuit 100, and the data line driver circuit 200 are assumed to be formed on the element substrate of the liquid crystal panel.

In the image display area A, n (n is a natural number of 2 or more) scanning lines 10 and m (m is a natural number of 2 or more) data lines 20 are provided, and n×m pixels are provided to correspond to intersections of the scanning lines 10 and the data lines 20. In the pixel 50, while not shown in the drawing, light is incident from a back light, and the transmittance is adjusted. For this reason, the light is modulated so that the gray-scale display can be performed. In the first embodiment, a transmission type liquid crystal panel is exemplified, but it is a matter of course that a reflective or semi-transmissive reflective liquid crystal panel may be used.

The control circuit 300 generates an X transfer start pulse XSP, an X transfer direction command signal RL, an X clock signal XCK, and video data VD and the like to supply these signals to the data line driver circuit 200, and concurrently generates a Y transfer start pulse YSP, a Y transfer direction command signal UD, a Y clock signal YCK, and the simultaneous output command signal DS and the like to supply these signals to the scanning line driver circuit 100.

The electric configuration of the pixel 50 is shown in FIG. 2.

The pixel 50 includes a pixel circuit P1. The pixel circuit P1 includes a liquid crystal element 60, a selection transistor 51 which is provided between the data line 20 and the liquid crystal element 60, and a retentive capacitance 52.

Among these components, the selection transistor 51 includes the CMOS (Complementary Metal Oxide Semiconductor) structure as shown in the drawing. Although the scanning line 10 is illustrated as one line in FIG. 1 for the sake of simplicity, it actually includes two lines 11 and 12 as shown in FIG. 2 according to the included CMOS structure of the selection transistor 51. To each of the lines 11 and 12, the scanning line driver circuit 100 supplies scanning signals GL and /GL which are in a complementary relation to each other (Hereinafter, the scanning signals GL and /GL may be collectively referred to as “a scanning signal Y”. Refer to FIGS. 1 and 2). The selection transistor 51 comes to be in an electrically connected state or an electrically non-connected state for the data line 20, as viewed from the liquid crystal element 60, according to the state of the scanning signals GL and /GL.

The liquid crystal element 60 includes a pixel electrode 53 and a counter electrode 54, and the liquid crystals LC are interposed therebetween.

Among these components described above, the selection transistor 51 and the pixel electrode 53 are formed on the element substrate, and the counter electrode 54 is formed on the counter substrate. The counter electrode 54 is formed over the entire surface of the counter substrate, and is provided in common over the entire pixel 50. In addition, one ends of the counter electrode 54 and the retentive capacitance 52 are connected to a capacitance line 30 (Further, the other end of the retentive capacitance 52 is connected to the pixel electrode 53.). The common potential VCOM is supplied to the capacitance line 30 from the power supply circuit 400 (refer to FIG. 1 as well).

Further, the potential of the counter electrode 54 and the potential of one end of the retentive capacitance 52 are the same as those of the first embodiment, but these may be set separately. As described in the first embodiment, in the case where both potentials are provided in common, the configuration of the power supply circuit 400 can be advantageously simplified.

The pixel 50 is connected to a data potential supplying line 70. Between the data potential supplying line 70 and the data line 20 in the image display area A, there is provided a sample and hold transistor 75 (Hereinafter, it may be abbreviated as “SH transistor 75”.). The SH transistor 75 is the same as the selection transistor 51 described above, including the CMOS structure, and being connected to two control lines. These control lines are supplied with selection signals S and /S which are in a complementary relation to each other (Hereinafter, the selection signals S and /S may collectively referred to as “a selection signal SH”. Refer to FIG. 2 as well.). The SH transistor 75 comes to be in an electrically connected state or an electrically non-connected state for the data potential supplying line 70, as viewed from the data line 20, according to the state of the selection signals S and /S. Further, the data potential supplying line 70 and SH transistor 75 described above configure a part of the data line driver circuit 200.

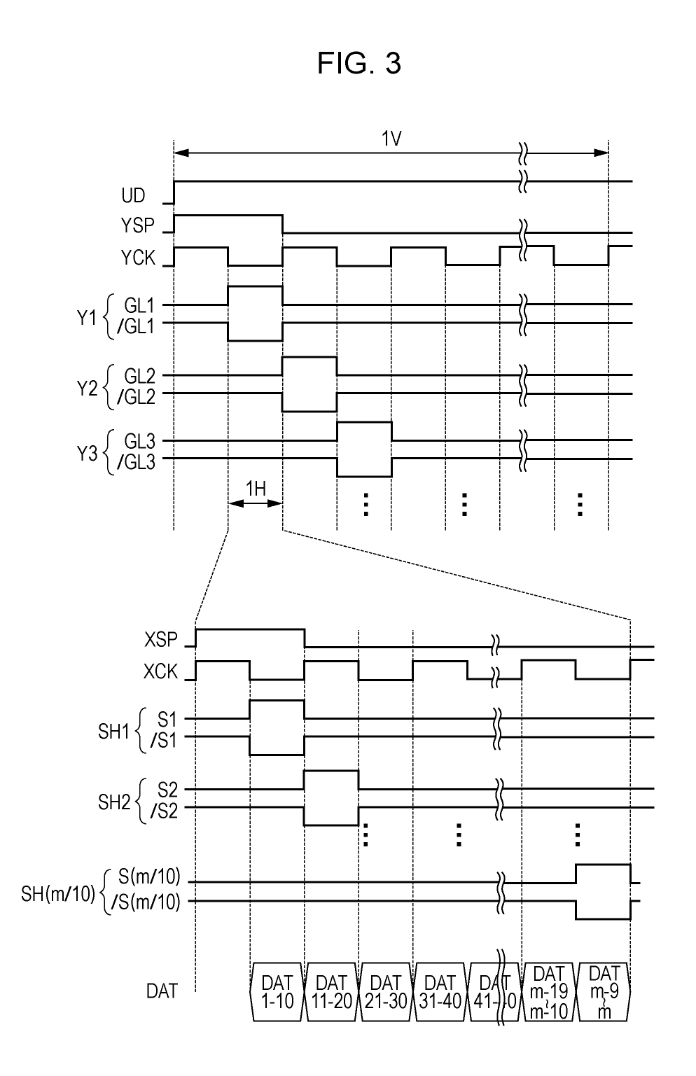

Next, the operation and the effect of the electro-optical device 1A configured as described above will be described with reference to FIGS. 3 to 7 including FIGS. 1 and 2 which have been referred above.

First, basic configurations of the electro-optical device 1A according to the first embodiment will be described in its entirety.

The basic operation of the electro-optical device 1A is to maintain unique data potentials DAT for the respective pixels 50 which are arranged in a matrix shape shown in FIG. 1. In this case, various schemes may be employed regarding what the order of the pixels 50 is applied to maintain the data potentials DAT. Typically, the scheme shown in FIG. 3 can be employed preferably.

In other words, in FIG. 3, first, a first row of the scanning line 10 is supplied with a scanning signal Y1 for activation. Here, the scanning signal Y1 is configured with the scanning signals GL1 and /GL1. Therefore, the activation of the scanning signal Y1 means that the scanning signal GL1 ascends from the low level to the high level and the scanning signal /GL1 descends from the high level to the low level as shown in FIG. 3 in the first embodiment. For this reason, the selection transistors 51 in the pixels 50 belonging to the first row come to be in the turned-on state (up to this point, refer also to FIG. 2).

On the other hand, in synchronization with the turned-on state of the selection transistor 51, when the selection signal SH is activated, the SH transistor 75 comes to be in the turned-on state (refer to FIG. 2). In this case, the meaning of the activation of the selection signals SH is also about the same as the case of the scanning signal Y described above. In other words, the activation of the selection signal SH means that the selection signal S ascends from the low level to the high level and the scanning signal /S descends from the high level to the low level in the first embodiment.

Further, FIG. 3 shows an example in which the data lines 20 shown in FIG. 1 form a unit at every ten columns, and at one chance ten data potentials DAT1 to 10 are concurrently supplied to the image display area A. In the drawing, like the symbols SH1, SH2, . . . , S1, S2, . . . , /S1, /S2, . . . (inter alia “1” and “2”), the numbers are attached to the signs because the SH transistors 75 corresponding to the ten data potentials DAT (or ten data lines 20) are represented by these numbers one by one.

In the above description, the data potential supplying lines 70 are supplied with the data potentials DAT1, 2, . . . , 10 at proper timing. The data potentials DAT1, 2, . . . , 10 are written, via the SH transistors 75 and the selection transistors 51, to the liquid crystal elements 60 corresponding to the respective the data potentials DAT1, 2, . . . , 10. Hereinafter, the subsequent data potentials DAT11, . . . , 20 are also the same. Further, the symbol SH(m/10) (in particular, inter alia “m/10”) representing the selection signal corresponding to the writing of the final data potential DATm denotes that the number of the data lines 20 is m. In addition, the symbol denotes that the writing of the data potentials DAT is performed every ten data lines 20 as described above.

After the final data potential DATm is written, when the scanning signal Y1 is deactivated, the selection transistors 51 comes to be in the turned-off state, and the written data potentials DAT1, . . . , m are retained. Although the actual selection transistors 51 do not come to be in the completely turned-off state but to generate a constant leakage current, the retentive capacitances 52 reduce the influence of the leakage current to improve the retention characteristic of the data potentials DAT1, . . . , m.

Through the operations described above, the respective pixels 50 positioned on the first row can retain the unique data potentials DAT.

The subsequent operations are performed by repeating the above-mentioned operations. In other words, subsequently, during the scanning signal Y2 for activation is being supplied to the second row of the scanning line 10, the selection signals SH are activated and the data potentials DAT are supplied to the above-mentioned every unit of the data lines 20. The subsequent operations of the third row are also the same.

Further, in the above description, the timing at which the scanning signals Y1, Y2, Yn are activated corresponds to the Y clock signal YCK as shown in FIG. 3. In addition, the point of time when the scanning signal Y1 relating to the first row is activated responds to the timing at which the Y transfer start pulse YSP is activated. These situations are also about the same as the case of the selection signal SH; the timing at which the selection signals SH1, SH2, . . . are activated corresponds to the X clock signal XCK; and the point of time when the selection signal SH1 relating to the first row is activated responds to the timing at which the X transfer start pulse XSP is activated.

As a result, all of the pixels 50 have maintained each their unique data potentials DAT. Further, in FIG. 3, the reference numeral designated by “1H” means the period taken for writing the data potentials DAT to the pixels 50 of one row (one horizontal scanning period); and the reference numeral designated by “1 V” means the period taken for writing the data potentials DAT to all of the pixels 50 (one vertical scanning period). The latter period, in particular, may be referred to as one frame or one frame period in the following description.

The above description has been made as for the basic operations of the electro-optical device 1A, and besides this operations, the first embodiment includes various kinds of features as described in the following.

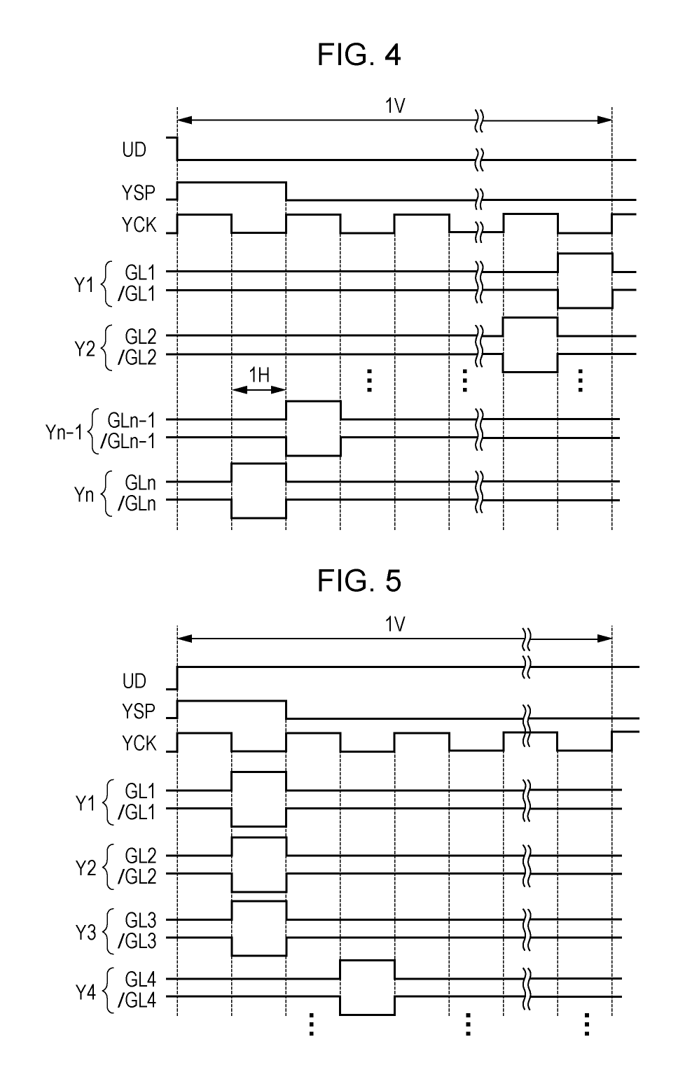

Firstly, in the electro-optical device 1A according to the first embodiment, as shown in FIG. 4, the transfer direction of the scanning signals Y may be opposite to that in the case shown in FIG. 3. This switching depends on the state of the Y transfer direction command signal UD. In other words, as shown in FIG. 4, when the Y transfer direction command signal UD is at a low level, the scanning lines 10 are selected in the order from the lower side of FIG. 1; and when the Y transfer direction command signal UD is at a high level (that is, the case shown in FIG. 3), the scanning lines 10 are selected in the order from the upper side of FIG. 1. For example, such an operation can be realized by varying the driving direction or the order of shift registers (not shown) constituting the scanning line driver circuit 100 according to the level of the Y transfer direction command signal UD.

Secondly, in the electro-optical device 1A according to the first embodiment, as shown in FIG. 5, a plurality of scanning lines 10 can be simultaneously selected at one time. FIG. 5 shows an example in which three scanning lines 10 are simultaneously selected sometimes, and thereafter the scanning lines 10 are selected sequentially every three lines.

For example, the above-mentioned operations can be realized by the scanning line driver circuit 100 which is configured such that the scanning signal Y for any one scanning line 10 in the common operation (FIG. 3 is taken into consideration) is also used for another scanning line which has a predetermined relationship with the one scanning line 10. In the first embodiment, in order to realize such configuration, a simultaneous output command signal DS (which is not shown in FIG. 5 and other drawings) is utilized.

Furthermore, thirdly, in the electro-optical device 1A according to the first embodiment, so-called inversion driving is performed in which a polarity of the voltage applied to the liquid crystal element 60 is inverted at proper timing. In other words, the potential repeats at every constant period, that is, the potential of the pixel electrode 53 is either higher or lower than that of the counter electrode 54. In this case, as the inversion timing, various types described below may be conceivable.

[i] Inversion per frame unit: In this case, until all of the pixels 50 shown in FIG. 1 are driven once, regarding all of the pixels 50, for example, the potentials of the pixel electrodes 53 are always higher than those of the counter electrodes 54, but those are opposite in the next frame (the V inversion scheme).

[ii] Inversion per data line unit: In this case, during a period of any one frame, the potential of the pixel electrode 53 of the pixel 50(i, j) is higher than that of the counter electrode 54, but it is opposite to the adjacent pixel 50(i, j+1) (the S inversion scheme).

[iii] Inversion per Scanning line unit: In this case, during a period of any one frame, when the pixels 50(i, 1), . . . , P1(i, n) positioned on any one row are driven, the potentials of the pixel electrodes 53 are higher than those of the counter electrodes 54, but when the pixels 50(i+1, 1), . . . , P1(i+1, n) positioned on the next row are driven, those are opposite (the H inversion scheme).

[iv] Inversion per pixel unit: In this case, the above-mentioned S inversion scheme and the H inversion scheme are used together (the dot inversion scheme).

The invention is not limited to the specific types of the various inversion timing. Further, in the following description, a period during which the height relationship between the potentials of the pixel electrode 53 and the potentials of the counter electrode 54 remain without change, that is, one period which is partitioned by the above-mentioned various kinds of the inversion timing (For example, in the case of [iii], it matches with one horizontal scanning period) may be called one field or one field period.

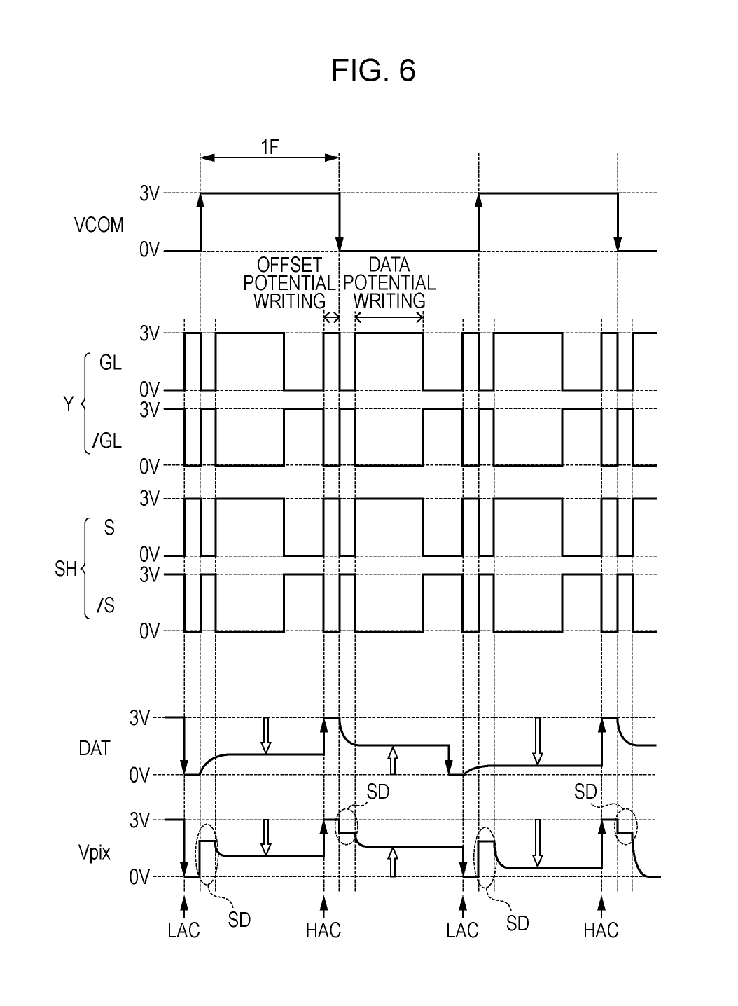

Fourthly, the electro-optical device 1A according to the first embodiment is characterized in that the operations as described in the following are performed on the assumption of all or a part of the first to third features. Hereinafter, these operations will be described with reference to FIG. 6. Further, in FIG. 6, for simple description, it is assumed that the pixel 50 is only one, that is, the pixel 50 which is a writing object of the data potential DAT is one, and when the writing to the corresponding pixel 50 is completed, the pixel 50 is again written immediately thereafter. Therefore, in FIG. 6, it is assumed that there is also one scanning line 10 (that is, there is only one line 11 and only one line 12), also one data line 20, and also one SH transistor 75 (refer to FIG. 2).

First, in FIG. 6, an inversion pattern in which the common potential VCOM of the counter electrode 54 is inverted at every constant period 1F is depicted. The one field period 1F, which is referring here, may be equivalent to the one vertical scanning period or to one horizontal scanning period as described above, but in FIG. 6, since it is assumed that the pixel 50 is only one, it can be considered as suitable for any of the above items [i] to [iv] (Since the pixel 50 is only one, it may be easy to understand that the “dot inversion scheme” is considered to be suitable).

In FIG. 6, according to the variation in the potential VCOM of the counter electrode 54, the data potential DAT has by nature two kinds of potentials which can be divided into a potential corresponding to a high potential reference and a potential corresponding to a low potential reference. In other words, a first kind of potential corresponds to the case where the common potential VCOM is high (“3 V” in FIG. 6), and a second kind of potential corresponds to the case where the common potential VCOM is low (“0 V” in FIG. 6). In the former case, VCOM≧DAT, and in the latter case, DATV≦COM, so that in any of these cases the potential difference between the two is applied to the liquid crystal element 60 (refer to the bold arrow in FIG. 6). The level of the difference between the two (that is, the length of the bold arrow in FIG. 6) determines the ratio of an amount of light transmitted through the liquid crystal element 60, that is, the level of gradation.

Further, in the bottom of FIG. 6, a variation pattern in the potential Vpix (Hereinafter, this may be referred to as the pixel potential Vpix) at node Z1 in the pixel 50 shown in FIG. 2 is depicted. As a matter of course, the pixel potential Vpix varies according to the variation in the data potential DAT. However, in the pixel potential Vpix, there can be found a pattern in which specific potential variations occur as shown by ellipses designated with the symbol “SD”. Regarding this point, it will be explained again later.

In the first embodiment, for this situation, the offset potential writing operation is performed as shown in FIG. 6. The details thereof will be as follows.

The offset potential writing operation is performed prior to the writing operation of the data potential DAT to the above-mentioned pixel 50. More properly, the operation precedes the inversion timing of the common potential VCOM. In other words, when the common potential VCOM varies from the low potential to the high potential, the scanning signal Y and the selection signal SH are activated together, and the data potential DAT becomes the potential that the counter electrode 54 had possessed, that is, the potential on the side of the low potential. Therefore, the pixel 50 is written with the low potential (refer to the symbol “LAC” in FIG. 6) just like the resistance to the common potential VCOM which just varies to the high potential.

On the other hand, even when the common potential VCOM varies from the high potential to the low potential, the same operation is performed. However, in this case, the pixel 50 is written with the high potential (refer to the symbol “HAC” in FIG. 6) just like the resistance to the common potential VCOM which just varies to the low potential.

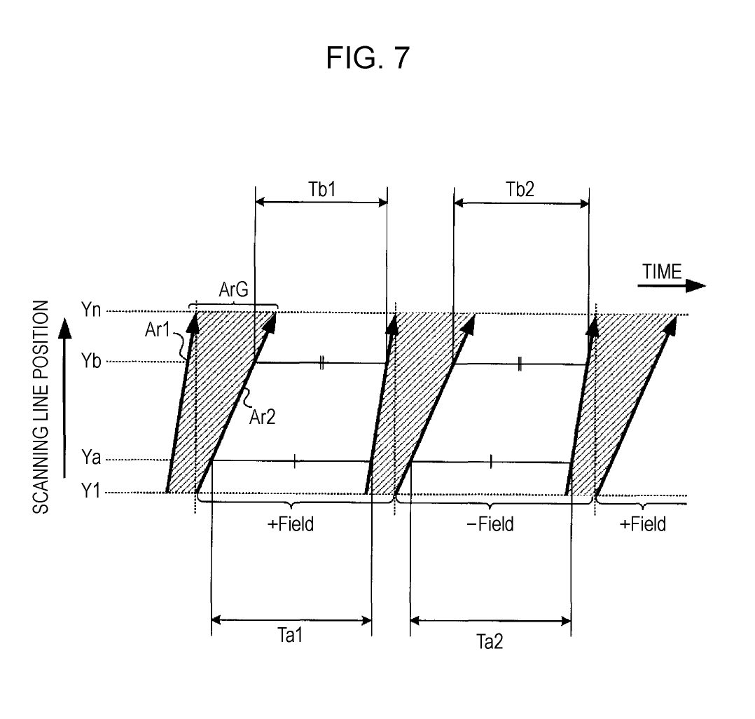

The operation shown in FIG. 6 can be realized, for example, as shown in FIG. 7 when it is considered that the operation is performed when n×m pixels 50 exist as shown in FIG. 1.

In FIG. 7, the vertical direction in the drawing represents the positions of the respective scanning lines 10. In other words, “Y1” shown in the lower side of FIG. 7 represents the scanning line 10 positioned on the top of FIG. 1, and “Yn” shown in the upper side of FIG. 7 represents the scanning line 10 positioned on the bottom of FIG. 1. In addition, the horizontal direction of FIG. 7 represents the temporal progress (In addition, for confirmation, the symbol “Y” or “Y1”, “Y2”, . . . directly means “a scanning signal” as described above, but in FIG. 7 its meaning is diverted to the scanning line 10).

The arrows Ar1 and Ar2 drawn in the space, which is formed by the positions of the scanning lines 10 and time, represent a pattern in which the scanning lines 10 are sequentially selected. In other words, any one arrow represents that the first row of the scanning line 10 is selected at the base end of any one arrow, and the second row, third row, . . . of the scanning lines 10 are gradually selected as time goes by, and then the n-th row of the scanning line 10 is selected at the leading end of the arrow. In addition, for this reason, the slope of the arrow represents an average value of the selection rate (In the specification, this may be referred to as “an average selection rate”) which is based on the time when all of the scanning lines 10 are selected. Further, the scanning lines 10 selected at a given time are positioned on a straight line traversing the time axis shown in FIG. 7 vertically, and thus if the corresponding arrow is strictly depicted, the arrow will be in a staircase pattern so to speak. The term “average” in the “average selection rate” means that this fine structure is ignored.

Further, “+Field” and “−Field” in FIG. 7 mean “1F” shown in FIG. 6, that is, the one field period. In addition, the signs “+” and “−” attached before the symbol “Field” appear alternatively, which mean the “inversion” as described with reference to FIG. 6. Further, the one field period shown in FIG. 7, may be considered as the substantially synonym of the one frame period based on the meaning of the arrows Ar1 and Ar2 described above.

On the assumption described above, FIG. 7 shows arrow groups ArG which are correlated with hatching, and each of which includes two arrows. The left arrow Ar1 in the drawing represents the selection pattern of the scanning lines 10 relating to the offset potential writing operation described above, and the right arrow Ar2 in the drawing represents the selection pattern of the scanning lines 10 relating to the data potential writing operation.

Therefore, in FIG. 7, it can be seen that the average selection rate of the scanning lines 10 when the offset potential writing operation is performed is greater than that when the data potential writing operation is performed.

The reason that such an operation can be performed is because the above-mentioned second feature is activated. In other words, when the offset potential writing operation is performed, a plurality of the scanning lines 10 is selected at the same time. Further, even though such a selection has been performed, the offset potential varies in proportion to the value of the common potential VCOM and all of the pixels 50 are selected uniformly, so that it does not pose a specific problem. On the contrary, regarding the data potential DAT, it is generally necessary to write different data potentials DAT to all of the pixels 50 respectively, so that the simultaneous selection of the plurality of the lines may not be performed as a principle.

The difference in the both slopes of the arrows Ar1 and Ar2 in FIG. 7 is based on this reason.

With the above situation as a background, the following facts can be detected from FIG. 7.

[A] A period of time necessary for selecting all of the scanning lines 10 when the offset potential writing operation is performed is shorter than a period of time necessary for selecting all of the scanning lines 10 in the data potential writing operation. Similarly, in other words, the average selection rate relating to the former case is greater than that of the latter case.

[B] In FIG. 7, the space (which is the hatched space in the drawing) interposed between the arrows Ar1 and Ar2 relating to the offset potential and data potential writing operations represents a period of time during which an image is not displayed in the image display area A of FIG. 1. Further, since the both arrows An and Ar2 are different in their slopes as described above, the length of the non-display period shortens by the low-numbered scanning line 10 (that is, the scanning line 10 positioned further up in FIG. 1).

[C] In FIG. 7, the space between the arrow Ar2 relating to the data potential writing operation and the arrow Ar1 relating to the offset potential writing operation which is positioned on the right side in the drawing represents a period of time during which an image is displayed in the image display area A of FIG. 1. Further, as described in

[B], the lower the numbering of the scanning line 10 is, the shorter the image non-display period is; in contrary, the image display period lengthens as the numbering of the scanning line 10 is lower.

According to the electro-optical device 1A as described above, the following effects can be obtained.

(1) First, according to the electro-optical device 1A of the first embodiment, the effects as described below can be obtained regarding the offset potential writing operation which has been described with reference to FIG. 6.

In other words, by performing the offset potential writing operation, as described above, the pixel 50 maintains the potential against an inverted potential just before the timing at which the potential of the counter electrode 54 is inverted. As a result, as shown by the symbols “LAC” and “HAC” of FIG. 6, the pixel potential Vpix takes a behavior opposite to the common potential VCOM of the counter electrode 54.

By the way, when the potential of the counter electrode is inverted, the pixel potential Vpix varies due to a coupling action between the liquid crystal element 60 and the retentive capacitance 52. This is the reason of the potential variation shown in the ellipse SD of FIG. 6, which has been postponed from the above description. In other words, when the common potential VCOM transits from the low potential to the high potential, the pixel potential Vpix also varies to jump up to the high potential side according to the transition. Even when the common potential VCOM transits from the high potential to the low potential, the situation is the same.

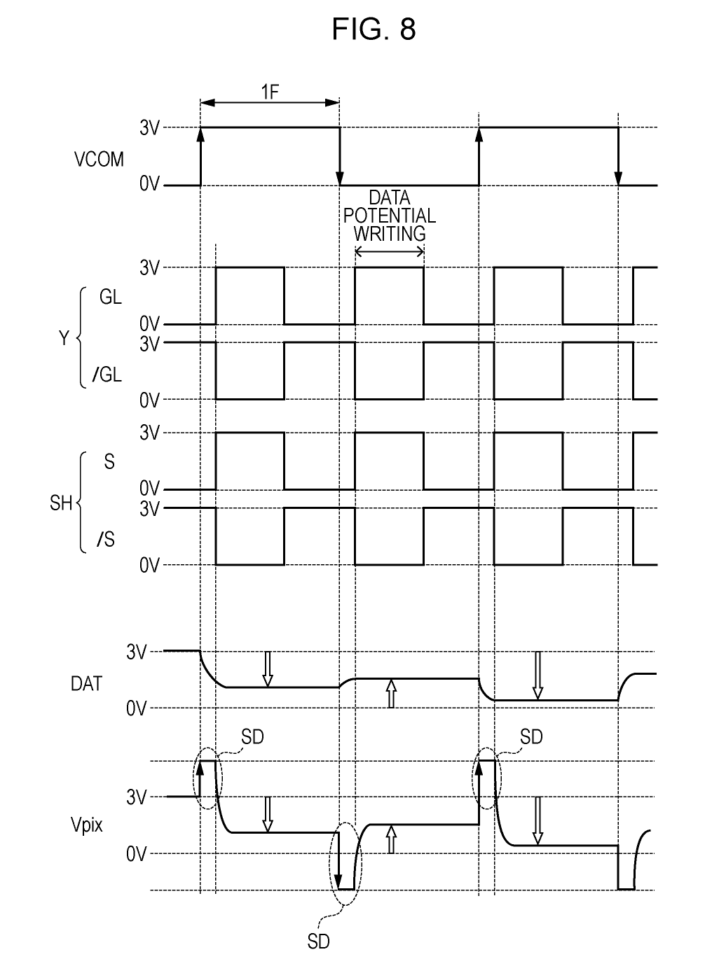

Here, the case where the offset potential writing operation is not performed is assumed. FIG. 8 shows an example in this case. According to the example, the level of the pixel potential Vpix at the point of variation in the common potential VCOM is raised or lowered further more during the offset potential is not written. Therefore, in this case, if the potential variation occurs in the common potential VCOM, there is a strong possibility that the amplitude of the potential variation in the ellipse SD may exceed a permissible amplitude which has been intended at first as the potential variation of the pixel potential Vpix. FIGS. 6 and 8 show examples in which the common potential VCOM varies from 0 V to 3 V. The potential variations in the ellipse SD also are preferably generated in the same amplitude, but in FIG. 8, a lower limit is equal to or less than 0 V, and an upper limit is equal to or more than 3 V.

If such a situation occurs, first of all, there is concern that a desired image display may be difficult to perform.

In addition, in order to operate the electro-optical device 1A without any problem even when the potential variation exceeding the permissible amplitude occurs, it is necessary to improve breakdown voltage performance of the selection transistor 51 shown in FIG. 2. However, this requires an upsizing scale of the selection transistor 51 and becomes an obstacle to high definition of the display image.

In this regard, as it is apparent from the comparison between FIGS. 6 and 8, the concern about the above-mentioned defects in the first embodiment is reduced remarkably. This is because, as described above, the offset potential is written to the pixel 50 immediately before the inversion timing of the common potential VCOM in the first embodiment. Therefore, even when a variation occurs in the pixel potential Vpix due to the inversion of the common potential VCOM and the coupling action, since the offset potential that has been written previously serves as a kind of buffer so to speak, much of the variation amplitude, in this sense, is absorbed into the buffer. As a result, the variation amplitude of the pixel potential Vpix can be locked between 0 V and 3 V as shown in the drawing.

(2) In addition, according to the electro-optical device 1A of the first embodiment, although (1) the operational advantage of the above-mentioned offset potential is related, since low-voltage driving can be preferably implemented, the selection transistor 51 including the CMOS structure can be preferably used as shown in FIG. 2, and alternatively all kinds of effects such as low power consumption can also be obtained.

(3) Furthermore, according to the electro-optical device 1A of the first embodiment, as described with reference to FIG. 7, the average selection rate of all of the scanning lines 10 relating to the offset potential writing operation is greater than that relating to the data potential writing operation. Therefore, the effect that the display characteristics are improved such that a brighter image can be displayed in the electro-optical device 1A is obtained.

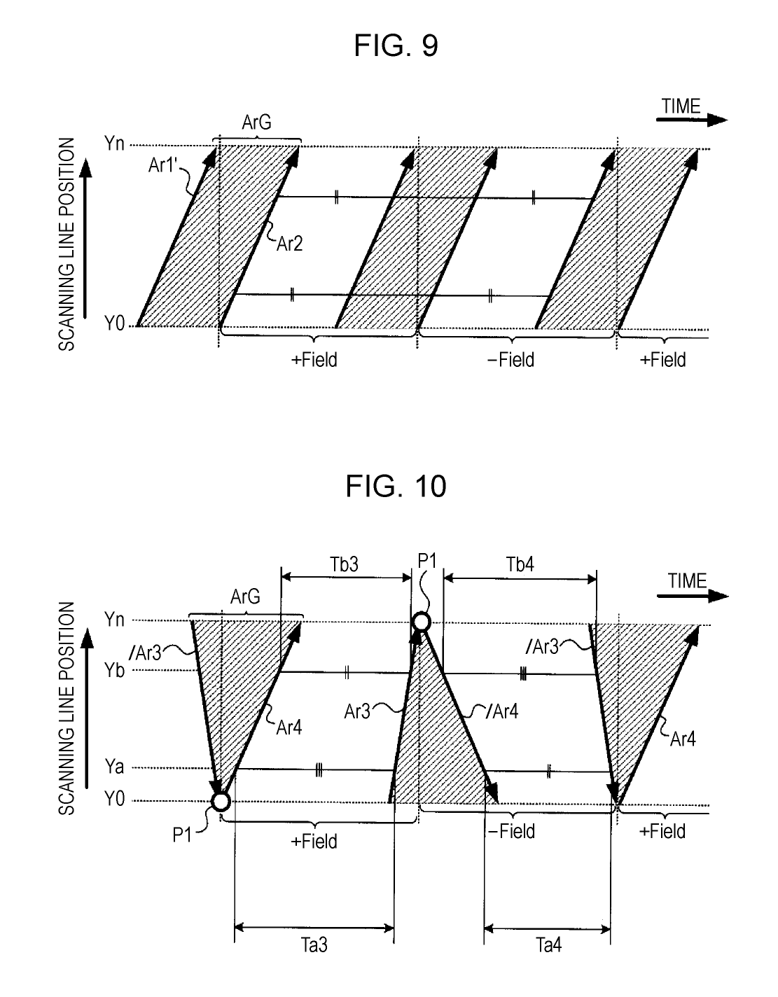

This will be clearly understood through a comparison between FIGS. 7 and 9.

In FIG. 9, the average selection rate of all of the scanning lines 10 in the offset potential writing operation is the same as that in the data potential writing operation. In other words, the slopes of the arrow Ar1′ and the arrow Ar2 are exactly the same. However, it is clear that the areas of the hatched portions in FIG. 9 are enlarged more than those in FIG. 7. This means the extension of the image non-display period (refer to [B] described above) or, as a result of it, the reduction of the image display period (refer to [C] described above). Eventually, in the case of FIG. 9, the addition of the writing operation of the offset potential causes a darker image to be displayed, so that there is likely to degrade the display characteristics.

In this regard, in FIG. 7, the concern of the above-mentioned defects is reduced remarkably. In FIG. 7, since the average selection rate in the offset potential writing operation is high, the image non-display period is shortened further more, and the image display period is lengthened.

### Second Embodiment

In the following, the second embodiment according to the invention will be described with reference to FIG. 10. Further, the second embodiment is characterized in the selection scheme of the scanning lines 10 when the offset potential or the data potential are written, and further points are the same as the configuration, and the operations or the actions of the first embodiment. Therefore, in the following, the differences will be mainly described, and the description of further points will be appropriately simplified, that is, omitted.

In the second embodiment, as shown in FIG. 10, the selection scheme of the scanning lines 10 relating to the offset potential and data potential writing operations are different from that of FIG. 7. In other words, in FIG. 10, an inversion function of the Y transfer direction is used, which has been described as a first feature point of the electro-optical device 1A of the first embodiment.

More specifically, in FIG. 10, when the selection of all of the scanning lines 10 relating to the offset potential writing operation starts from the first row of the scanning line 10 and is ended at the n-th row of the scanning line 10 (refer to the arrow Ar3 in the drawing). Subsequently to the above selection, the selection of the scanning lines 10 relating to the subsequent data potential writing operation starts from the n-th row and is ended at the first row (refer to the arrow /Ar4 in the drawing). On the other hand, when the selection of all of the scanning lines 10 relating to the offset potential writing operation starts from the n-th row of the scanning line 10 and is ended at the first row of the scanning line 10 (refer to the arrow /Ar3 in the drawing). Subsequently to the above selection, the selection of the scanning line 10 relating to the subsequent data potential writing operation starts from the first row and is ended at the n-th row (refer to the arrow Ar4 in the drawing). Then, these two schemes are alternatively repeated.

Further, although the transfer direction is regular, in FIG. 10, each of the average selection rates relating to the offset potential writing operation and the data potential writing operation is constant with respect to all the fields (that is, the slopes of the arrows Ar3 and /Ar3 are the same if the inverted polarity is ignored, and the slopes of the arrows Ar4 and /Ar4 are also the same if the inverted polarity is ignored).

As a result obtained from the selection scheme of the scanning lines 10, in FIG. 10, comparing with FIG. 7, it is able to remove a bias in the length of the image display period according to the positions of the respective scanning lines 10.

In other words, in consideration of the image display period relating to the positions of two scanning lines 10 represented by “Ya” and “Yb”(a<b) shown in FIGS. 7 and 10, each of the image display periods of “Ya” and “Yb” of FIG. 7 does not vary even though time goes by. In other words, regarding FIG. 7, Ta1=Ta2 and Tb1=Tb2. While not shown in the drawing, the same is true for the periods thereafter. Furthermore, in the case of FIG. 7, Ta1>Tb1 is established between the two, and there is no variation even in this relation at all as time goes by. In other words, Ta1 (or Ta2)>Tb1 (or Tb2) is established at any time.

However, if it is true, the image display period at the position of the scanning line 10 relating to “Yb” is always shorter than the image display period at the position of the scanning line 10 relating to “Ya”. Therefore, when the entire image is continuously observed for a finite period of time, an observer may be provided the image in which the upper side in FIG. 1 is always bright, but the lower side thereof is always dark.

In this regard, in the case of FIG. 10, the relation of Ta3>Ta4 is established between the image display periods Ta3 and Ta4 at the position of the scanning line 10 relating to “Ya”, and the relation of Tb3<Tb4 is established between the image display periods Tb3 and Tb4 at the position of the scanning line 10 relating to “Yb”. Furthermore, Ta3=Tb4 and Ta4=Tb3 are established. As a result, Ta3+Ta4=Tb3+Tb4 is established. The reason that the relation is established is because the inversion of the Y transfer direction as described above is performed as for the selection scheme of the scanning line 10.

As described above, in the case of FIG. 10, when it is observed along “Ya” or “Yb”, the image display period varies at every one frame, but when it is observed from two field periods as a unit, the image display periods relating to the two are just balanced.

Therefore, according to the second embodiment, the bias in the length (or the bias in the image brightness) of the image display periods according to the positions of the respective scanning lines 10, which can be seen in FIG. 7, can be removed.

### Third Embodiment

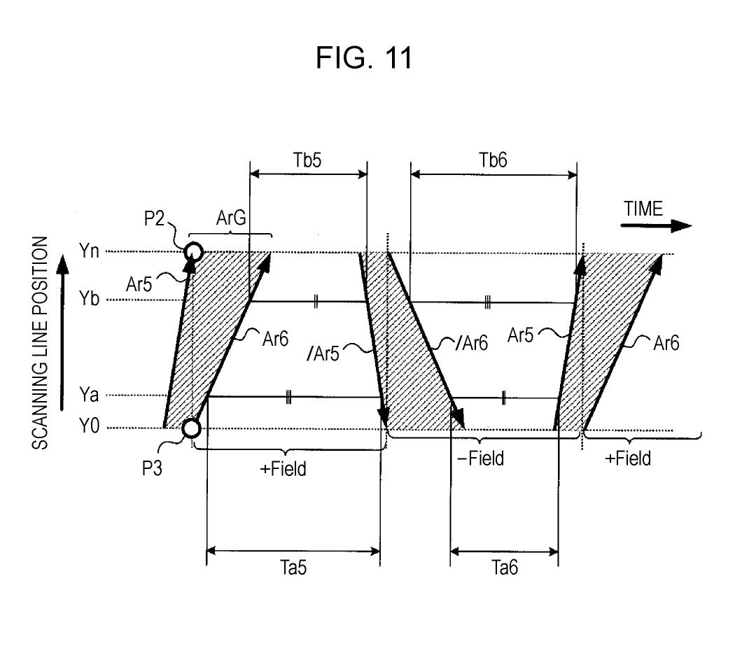

In the following, the third embodiment according to the invention will be described with reference to FIG. 11. Further, the third embodiment is characterized in the selection scheme of the scanning lines 10 when the offset potential or the data potential are written, and further points are the same as the configuration, and the operations or the actions of the first embodiment. Therefore, in the following, the differences will be mainly described, and the descriptions of further points will be appropriately simplified, that is, omitted.

In the third embodiment, as shown in FIG. 11, the selection schemes of the scanning lines 10 relating to the writing operations of the offset potential and the data potential are different from those of FIGS. 7 and 10.

More specifically, in FIG. 11, when the selection of all of the scanning lines 10 relating to the offset potential writing operation starts from the first row of the scanning line 10 and is ended at the n-th row of the scanning line 10 (refer to the arrow Ar5 in the drawing). Subsequently to the above selection, the selection of the scanning lines 10 relating to the subsequent data potential writing operation also starts from the first row and is ended at the n-th row (refer to the arrow Ar6 in the drawing). On the other hand, when the selection of all of the scanning lines 10 relating to the offset potential writing operation starts from the n-th row of the scanning line 10 and is ended at the first row of the scanning line (refer to the arrow /Ar5 in the drawing). Subsequently to the above selection, the selection of the scanning line 10 relating to the subsequent data potential writing operation also starts from the n-th row and is ended at the first row (refer to the arrow /Ar6 in the drawing). Then, these two schemes are alternatively repeated.

Further, although the transfer direction is regular, in FIG. 11, each of the average selection rates relating to the offset potential writing operation and the data potential writing operation is constant with respect to all the fields (That is, the slopes of the arrows Ar5 and /Ar5 are the same if the inverted polarity is ignored, and the slopes of the arrows Ar6 and /Ar6 are also the same if the inverted polarity is ignored).

As a result obtained from the selection scheme of the scanning line 10, first, the same operational advantage as FIG. 10 can also be obtained in FIG. 11. In other words, comparing with FIG. 7, the bias in the length of the image display period according to the positions of the respective scanning lines 10 can be removed. This is because, even in FIG. 11, the relation of Ta5>Ta6 is established at the position of the scanning line 10 relating to “Ya”; the relation of Tb5<Tb6 is established at the position of the scanning line 10 relating to “Yb”; and the relations of Ta5=Tb6 and Ta6=Tb5 are established, so that the relation of Ta5+Ta6=Tb5+Tb6 is established. As described above, even in the third embodiment, the maintenance and the improvement of the display characteristics are forecasted.

In addition, in FIG. 11, advantages as described below can also be obtained.

In other words, in the case of FIG. 10, a turning point P1 of the Y transfer direction is bound to exist in a set of the arrow group ArG. At the turning point P1, for example, since a transition occurs from the arrow /Ar3 to the arrow Ar4, the application of the selection voltage to the first row of the scanning line 10 (that is, the application of the scanning signal Y for activation) and according to this the writing operations of the offset potential and the data potential DAT are needed to be performed continuously. However, in such a driving scheme, an influence of the offset potential writing operation remains on the pixel 50 immediately before the driving (for example, a delay in the response characteristic caused by the influence of parasitic capacitance in the data line 20 itself), so that there is concern that the writing of the data potential DAT to the corresponding pixel 50 may not complete successfully. In addition, there is concern that the continuous driving for the liquid crystal element 60 as described above may not necessarily exert a positive influence on various characteristics such as the response characteristic of the corresponding liquid crystal element 60. Similarly, although there is some difference in level, since the pixels 50 corresponding to the scanning lines 10 near the first row of the scanning line 10, for example, the second, the third, . . . of the scanning lines 10 have no difference in being driven without relative gap therebetween, there is concern about this.

Further, when a transition occurs from the arrow Ar3 to the arrow /Ar4, the above-mentioned description will become the concern for the pixel 50 corresponding to the n-th row of the scanning line 10 or to the scanning lines 10 which are in the vicinity thereof.

In this regard, since the driving scheme as described above is employed in FIG. 11, there is no turning point P1 as shown in FIG. 10 in each of the arrow groups ArG. In other words, in FIG. 11, when the writing of the offset potentials to the pixels 50 corresponding to the scanning lines 10 from the first row to the n-th row is completed, for example, along the arrow Ar5 (refer to the symbol P2 in FIG. 11), subsequently to this, the writing (the writing along the arrow Ar6) of the data potential DAT to the pixel corresponding to the first row of the scanning line starts again (refer to the symbol P3 in FIG. 11). In other words, in this case, since the application of the selection voltage to the n-th row of the scanning line 10 or the writing of the data potential DAT to the pixel 50 corresponding to the scanning line 10 is continuously performed, there is no concern of the defects as described above. Further, the above-mentioned description is applied even when a transition occurs from the arrow /Ar5 to the arrow /Ar6.

As a result, according to the third embodiment, there is a strong possibility to display the image with high quality.

Further, it can say that the third embodiment gains an advantage over the second embodiment as for the meaning described above.

However, the characteristic that both of the writing operations of the offset potential and the data potential similarly start from the first row or n-th row of the scanning line 10, without the characteristic of the third embodiment as described above, that is, the turning point P1 as shown in FIG. 10, may have an opinion of having disadvantages compared with the second embodiment when viewed from the extension of the image display period (For example, refer to Ta6 of FIGS. 11 and Ta4 of FIG. 10 for contrast. The former is shorter that the later).

As described above, it cannot say that the second and the third embodiment are advantageous or disadvantageous completely. Which one of the above will be selected is a matter of determination which must be done in view of other various situations in addition to the above-mentioned situation (For example, a driving frequency. The higher the frequency is, the shorter the length of the actual time of the one field period is and it is considered that a negative effect of the continuous writing described above becomes larger, so that it can say that the third embodiment and FIG. 11 are more advantageous.).

Hereinbefore, the embodiments according to the invention have been described. However, the electro-optical device according to the invention is not limited to the above-mentioned embodiments, and various kinds of modifications can be made.

(1) In the above-mentioned first embodiment, the scanning lines 10 have been described to be selected by three with reference to FIG. 5, but the invention is not limited thereto. How many scanning lines 10 are to be selected simultaneously is a matter of determination which must be appropriately done in view of various situations. In particular, for example, considering the aspect that the average selection rate determines the brightness of the display image (refer to FIG. 7 and others), it may be employed the selection scheme in which a desired brightness is determined at each time and then according to this the average selection rate is determined (that is, determining the number of the scanning lines 10 which are selected simultaneously). In this case, the brightness of a display image can be set according to the setting of the average selection rate at each time, instead of by adjusting the data potential DAT.

In addition, in some cases, all of the scanning lines 10 may be selected simultaneously. In this case, while not shown in the drawing, for example, the arrow Ar1 in FIG. 7 is erected in the vertical direction in the drawing.

Furthermore, in this regard, in the respective embodiments described above, the arrow An of FIG. 7, the arrows Ar3 and /Ar3 of FIG. 10, or the arrows Ar1 and /Ar5 of FIG. 11 are assumed to always have the same slope (ignoring the inverted polarity) regardless of the lapse of time in each drawing, but the invention is also not limited thereto. In other words, in some cases, even the case in which the average selection rate in the offset potential writing operation varies at each time is included within the scope of the invention. Even as for modifications thereof, various cases can be assumed in which the selections vary alternatively in every one frame, or vary only in predetermined period of time, or vary according to a different transfer direction.

(2) In the second and third embodiments, the image display periods regarding the scanning lines 10 which are vertically positioned are balanced in two field periods as a unit, but the invention is not limited thereto.

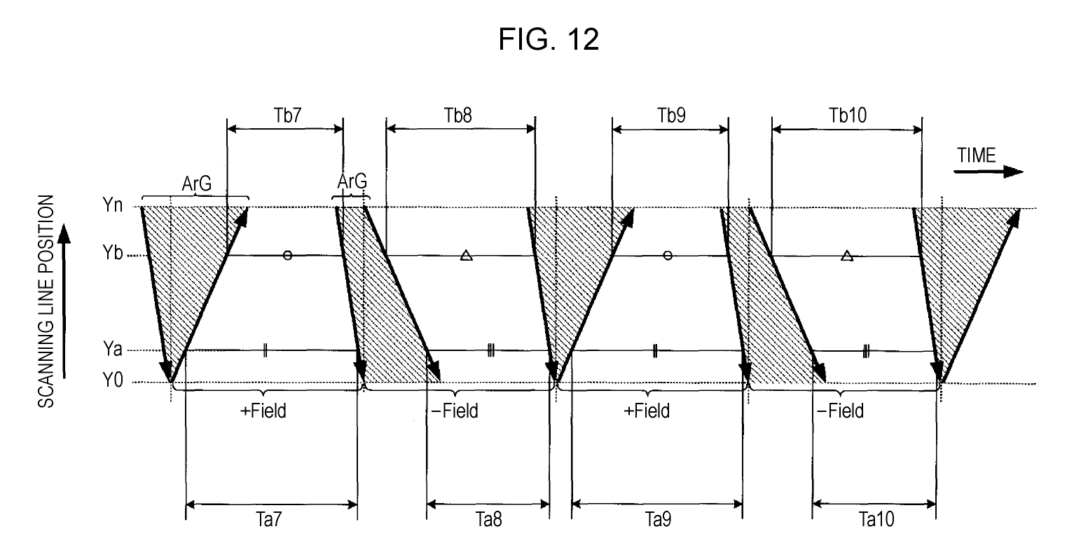

For example, in some cases, the scheme as shown FIG. 12 may be employed.

In FIG. 12, the arrow group ArG shown in FIG. 10 and the arrow group ArG shown in FIG. 11 are alternatively arranged in order from the leftmost side in the drawing. Further, in this case, the image display period relating to the symbol “Ya” varies from Ta1 to Ta10 as shown in FIG. 12, and on the other hand the image display period relating to the symbol “Yb” varies from Tb7 to Tb10. Then, in these regards, Ta7+Ta8=Tb7+Tb8 or Ta9+Ta10=Tb9+Tb10 is not established. However, Ta7+Ta8+Ta9+Ta10=Tb7+Tb8+Tb9+Tb10 is established.

In other words, in the case of FIG. 12, the image display period regarding the upper and lower scanning lines 10 as shown in FIGS. 10 and 11 is not balanced in two field periods, but in four field periods as a unit.

Similarly, in this scheme, it is apparent that an operational advantage which is essentially no different than that which can be obtained in each embodiment described above can be obtained.

By way of generalization, the invention is not specifically bound by what field must be used to balance the image display period. However, as can be seen from the examples of FIG. 12 or FIGS. 10 and 11, in general, it can say that the image display period relating to the scanning line 10 is preferably balanced between even numbers of the field periods. It is a matter of course that a scheme may be employed in which an odd number of the field periods is used for balance. However, in this case, there is concern that the variation in the average selection rate relating to the offset potential writing operation or the data potential writing operation may not be particularly practical.

(3) In the respective embodiments described above, there has been no particular mention on how to use the electro-optical device 1A, but the invention as an electro-optical device does not have a specifically limited usage.

For example, as described later, the electro-optical device 1A may be used as an image display device which is assembled in various kinds of electronic apparatuses.

In addition, the electro-optical device may be used as a stereoscopic image display device. For example, this includes an image display device which is capable of causing a parallax by displaying the right eye image and the left eye image alternatively to make a viewer feel a 3D appearance. In this case, for example, the respective image display periods appearing in FIG. 7 alternatively may be used as a display period for the right eye image and a display period for the left eye image, respectively.

(4) In the respective embodiments described above, the case where the grayscale of the liquid crystal element 60 is determined according to the length of the bold arrow shown in FIG. 6, that is, the case where a display gradation is determined according to a voltage amplitude, has been described, but the invention is not limited thereto.

For example, in addition to such a voltage amplitude, the display gradation of the liquid crystal element 60 may be determined using a digital code such as a pulse code or a PWM (Pulse Width Modulation), and even in this case the invention can be applied.

<Applications>

Next, the electronic apparatus to which the electro-optical device 1A according to the above-mentioned embodiments is applied will be described.

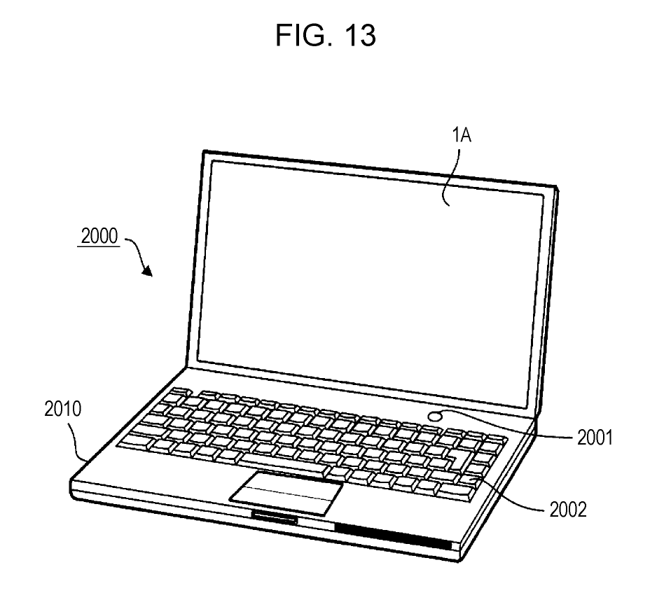

FIG. 13 is a perspective drawing illustrating the configuration of a mobile type personal computer in which the electro-optical device 1A according to the above-mentioned embodiments is applied to the image display device. The personal computer 2000 includes the electro-optical device 1A as a display device and a main body section 2010. In the main body section 2010, a power supply switch 2001 and a key board 2002 are provided.

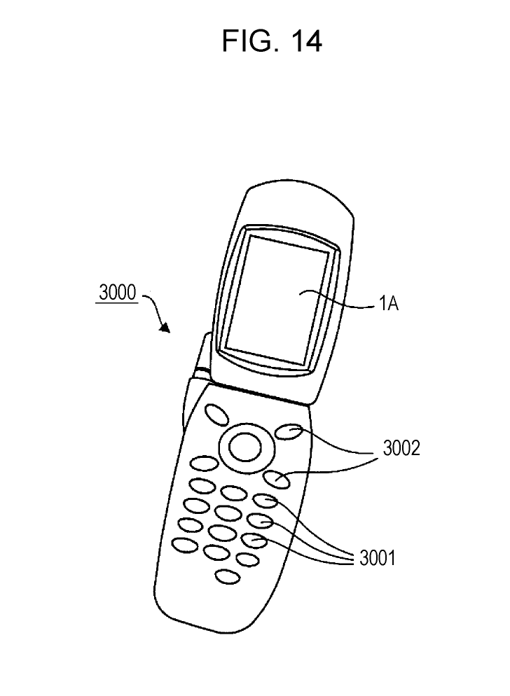

FIG. 14 shows a portable telephone to which the electro-optical device 1A according to the above-mentioned embodiments is applied. The portable telephone 3000 includes a plurality of operation buttons 3001 and scroll buttons 3002, and the electro-optical device 1A as a display device. By operating the scroll buttons 3002, a screen displayed in the electro-optical device 1A is scrolled.

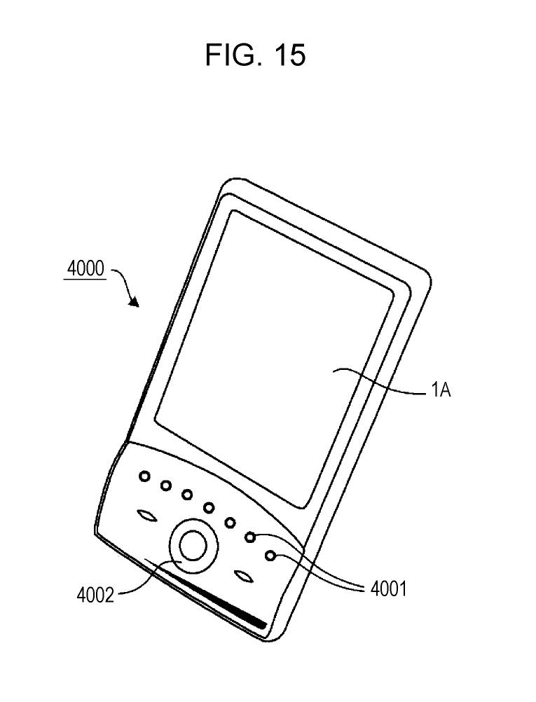

FIG. 15 shows a PDA (Personal Digital Assistant) to which the electro-optical device 1A according to the above-mentioned embodiments is applied. The PDA 4000 includes a plurality of operation buttons 4001, a power supply switch 4002, and the electro-optical device 1A as a display device. When the power supply switch 4002 is operated, a variety of information such an address book and a diary is displayed in the electro-optical device 1A.

As an electronic apparatus to which an organic EL device according to the invention is applied, in addition to the apparatuses shown in FIGS. 13 to 15, a digital still camera, a television, a video camera, a navigation apparatus, a pager, an electronic notepad, an electronic paper, an electronic calculator, a word processor, a workstation, a TV telephone, a POS terminal, a video player, and an equipment to which a touch panel is provided are exemplified.

### Reference Signs List

1A electro-optical device

A image display area

100 scanning line driver circuit

200 data line driver circuit

300 control circuit

10 scanning line

11, 12 line

20 data line

30 capacitance line

50 pixel

P1 pixel circuit

51 selection transistor

52 retentive capacitance

53 pixel electrode

54 counter electrode

60 liquid crystal element

LC liquid crystal

70 data potential supplying line

75 sample and hold transistor

UD Y transfer direction command signal

DS simultaneous output command signal

1F field period

VCOM common potential

DAT data potential

Vpix pixel potential

Y, GL, /GL scanning signal

SH, S, /S selection signal

Ar1-Ar6 arrow

ArG arrow group

Ta1-Ta10 image display period

Tb1-Tb10 image display period

1. An electro-optical device comprising:
a plurality of the pixels that are arranged in correspondence with intersections between a plurality of the scanning lines and a plurality of the data lines;
a polarity inversion unit that inverts a potential polarity of first electrodes at every constant period, the first electrodes constituting a part of the pixel;
a scanning line driver circuit that simultaneously selects two or more scanning lines of the plurality of the scanning lines or individually each of the plurality of the scanning lines until all of the plurality of the scanning lines are selected; and
a data line driver circuit that outputs a data potential corresponding to a potential polarity of the first electrode to each of the plurality of the data lines,
wherein each of the plurality of the pixels includes
a second electrode that faces the first electrode,
an electro-optical material that is interposed between the first and the second electrode, and
a switching element that is disposed between the second electrode and the data line and comes to be in an electrically connected state by selecting one scanning line corresponding to a pixel among the plurality of the scanning lines so as to make the second electrode electrically connected with a corresponding data line,
wherein before a first time point that is an inversion point at which the polarity inversion unit inverts a potential polarity of the first electrode,
the scanning line driver circuit simultaneously selects two or more scanning lines of the plurality of the scanning lines, and
the data line driver circuit outputs an offset potential which has a potential opposite to a potential polarity of the first electrode after the first time point to the data line, and
wherein after the first time point,
the scanning line driver circuit individually selects each of the plurality of the scanning lines, and
the data line driver circuit outputs the data potential corresponding to a potential polarity of the first electrode after the first time point to the data line.

2. The electro-optical device according to claim 1, wherein a potential of the first electrode includes two types of values, V1 and V2, and
wherein the offset potential becomes V2 when a potential of the first electrode is V1, and becomes V1 when the potential of the first electrode is V2.

3. The electro-optical device according to claim 1, wherein the scanning line driver circuit selects a first, a second, . . . , and an n-th scanning lines which are of the plurality of scanning lines, from the first to the n-th or from the n-th to the first.

4. The electro-optical device according to claim 3, wherein at every first time point, the scanning line driver circuit inverts the selection direction when two or more scanning lines of the plurality of scanning lines are simultaneously selected before the first time point, with respect to the selection direction immediately before the first time point, and inverts the selection direction when the plurality of the scanning lines are individually selected after the first time point, with respect to the selection direction immediately before the first time point.

5. The electro-optical device according to claim 4, wherein at the specific first time point, the selection direction when the plurality of the scanning lines are individually selected after the first time point is inverted with respect to the selection direction when two or more scanning lines of the plurality of the scanning lines are simultaneously selected before the first time point.

6. The electro-optical device according to claim 4, wherein at the specific first time point, the selection direction when the plurality of the scanning lines are individually selected after the first time point is the same as the selection direction when two or more scanning lines of the plurality of the scanning lines are simultaneously selected before the first time point.

7. The electro-optical device according to any one of claims 3 to 6, wherein when one scanning line of the plurality of the scanning lines is selected at a second time point at which the plurality of the scanning lines are individually selected after the first time point and at a third time point at which two or more scanning lines of the plurality of the scanning lines are simultaneously selected before a new first time point after the first time point, and
when another scanning line of the plurality of the scanning lines is selected at a fourth time point corresponding to the second time point and at a fifth time point corresponding to the third time point,
a total sum of a predetermined period from the second time point to the third time point when the first time point is repeated is the same as a total sum of a predetermined period from the fourth time point to the fifth time point when the first time point is repeated.

8. The electro-optical device according to claim 7, wherein the predetermined period is the same as a period during which the constant period is repeated an even number of times.

9. An electronic apparatus comprising the electro-optical device according to claim 1.
